(19) United States
(12) Patent Application Publication
(10) Pub. No.: US 2003/0071051 A1
(43) Pub. Date: Apr. 17, 2003

(54) Dispensing of labels, stickers, decals and stamps from a spool of backing material

(76) Inventor: Lyle J. Martinsen, Murray, UT (US)

Correspondence Address: Foster & Foster LLC, Mr. Lynn G. Foster, 602 E. 300 S., Salt Lake City, UT, 84102, US

(21) Appl. No.: 09/900,633

(22) Filed: Jul. 6, 2001

Related U.S. Application Data
(60) Provisional application No. 60/216,703, filed on Jul. 7, 2000.

(51) Int. Cl. B65H 16/00; G07F 11/68; B32B 1/00

(52) U.S. Cl. 221/70; 242/588.3; 156/584

(57) ABSTRACT

Dispensers are disclosed for receiving a roll comprising a backing strip and labels, stickers, decals, stamps and the like releasibly adhered to one side of the backing strip and by which the backing strip is manually pulled from the dispenser causing the labels, stickers, decals, stamps and the like to be successively separated from the backing strip for adherence to a desired object, such as merchandise, envelopes, etc.

### CONTINUITY

The applicant claims the benefits of states provisional patent application Nos. 60/216,703, filed Jul. 7, 2000.

### FIELD OF INVENTION

The present invention relates generally to dispensing labels, stickers, decals, stamps and the like and, more particularly, to methods and apparatus by which labels, stickers, decals, stamps and the like are successively dispensed by separating the label, sticker, stamp and the like from a backing strip to which the label, sticker, decal, stamp or the like is initially removably adhered.

### BACKGROUND

Dispensers for peeling labels, stamps, stickers, decals and the like (hereinafter collectively and individually sometimes referred to as “labels”) are, broadly, well established in the art. There are, however, a number of deficiencies which have persisted in the label dispensing art including, but not necessarily limited to a lack of durability, failure to be and remain free standing, maintenance prone, instability, fragile and sometimes frangible, difficult to assemble, difficult to insert and remove a spool comprised of a backing strip and labels, stamps, decals or stickers, difficulty in facilely peeling each label from its adherence to the backing strip, premature adherence of the separated label to the dispenser itself, inadequate ability to inspect the spool, requiring technical training and competence for the user to operate, comprised complicated techniques for accessing to the interior of the dispenser, and required use of two hands to adequately achieve successive dispensing of labels from the backing strip.

By way of example, for many years the famous postage stamp consisted of a firm, relatively stiff piece of paper with a pre-dried glue backing which required the wetting of the glue before use. In recent years, a new stamp has emerged consisting of the same paper, but with a pre-applied adhesive on the back that does not require wetting before use. Of necessity this adhesive backed stamp is adhered to a controlled releasable backing strip. The backing strip is made of a tough thin especially treated paper, such as Kraft paper, which allows adherence but prevents a hard bond. Therefore, a roll of stamps can be transported and handled but each stamp is removable by peeling the stamp from the backing. This process typically requires both bending of the backing strip and peeling of the stamp, necessitating use of two hands. This process is slow and very restricting, especially when larger quantities of mail are to be stamped, or when a large number of point of sale labels are to be attached to products. This later use is of consequence in large department and other retail stores.

### BRIEF SUMMARY AND OBJECTS OF THE PRESENT INVENTION

In brief summary, the present invention addresses and either overcomes or substantially alleviates label, stamp, sticker, decal and the like dispensing problems of the past. The present invention, in its various forms or embodiments provides some or all of the following dispenser and dispensing advantages, characteristics and features, among others: (1) the dispenser can be internally inspected without disassembly; (2) the dispenser is durable, non-frangible and maintenance-tree, (3) the dispenser is stable and accommodates one-hand dispensing of a label, stamp, sticker or the like from a backing strip spool; (4) the dispenser can be assembled and/or used by persons with little or no technical training; (5) each label is successively, automatically and facilely mechanically peeled from a backing strip at a discharge site of the dispenser for adhered placement on a desired object; (6) each label is dispensed in such a way that the label is prevented from sticking to the dispenser adjacent to the label discharge site; (7) the spool comprising the coiled backing strip with labels adhered to one surface thereof can be easily inserted into and removed from the dispenser; (8) access to the interior of the dispenser is facilely achieved by removing a secure lid; (9) wherein the spool is either shaft or axle-mounted or turns contiguously upon an interior surface of the dispenser.

With the foregoing in mind, it is a primary object of this invention to address and either overcome or substantially alleviate label, stamp, sticker and the like dispensing problems of the past.

Another object of great significance is the provision of novel methods and unique apparatus by which some or all of the following label, sticker,decal, stamp and the like dispenser and dispensing advantages, characteristics and features, among others, are obtained: (1) the dispenser can be internally inspected without disassembly; (2) the dispenser is durable, non-frangible and maintenance-free, (3) the dispenser is stable and accommodates one-hand dispensing of a label from a backing strip spool; (4) the dispenser can be assembled and/or used by persons with little or no technical training; (5) each label is successively, automatically and facilely mechanically peeled from a backing strip at a discharge site of the dispenser for adhered placement on a desired object; (6) each label is dispensed in such a way that the label is prevented from sticking to the dispenser adjacent to the label discharge site; (7) the spool comprising the coiled backing strip with labels adhered to one surface thereof can be easily inserted into and removed from the dispenser; (8) access to the interior of the dispenser is facilely achieved by removing a secure lid; (9) wherein the spool is either shaft or axle-mounted or turns contiguously upon an interior surface of the dispenser.

These and other objects and features of the present invention will be apparent from the detailed description taken with reference to the accompanying drawings.

### BRIEF DESCRIPTION OF THE DRAWINGS

FIG. 1 is an exploded perspective of a first dispenser embodiment in accordance with the principles of the present invention for dispensing labels, stamps, stickers, decals and the like from a spool of backing strip material;

FIG. 2 is a side elevational view of the dispenser of FIG. 1, with the lid exploded into an elevated position;

FIG. 3 is a side elevation of the dispenser FIG. 1, similar to FIG. 2. but with the lid in its assembled position;

FIG. 4 is a perspective of a second dispenser embodiment in accordance with the present invention, in its assembled condition;

FIG. 5 is an exploded perspective of the dispenser of FIG. 4;

FIG. 6 is an enlarged fragmentary perspective of the top portion of the dispenser of FIG. 5, with the lid removed, showing how a coiled backing strip, with labels adhered to one surface thereof, is threaded into its label-dispensing position within the dispenser of FIG. 4;

FIG. 7 is a fragmentary perspective of the top portion of the dispenser of FIG. 4 with the lid in its assembled position, similar to FIG. 6, showing the backing strip with labels thereon in its fully threaded position, one label being separated from the backing strip;

FIG. 8 is an enlarged fragmentary cross sectional view illustrating the manner in which downwardly extending pins or dowels of the lid of the dispenser of the FIG. 4 are inserted into tapered blind bores disposed in side walls of the dispenser of FIG. 4;

FIG. 9 is an enlarged fragmentary cross section illustrating the serrations upon which a separated label is placed at the discharge site of the dispenser of FIG. 4;

FIG. 10 illustrates in perspective a third dispenser embodiment which embraces principles of the present invention;

FIG. 11 is an exploded perspective of the dispenser of FIG. 10; and

FIG. 12 is an enlarged fragmentary cross section of the top label discharge portion of the dispenser of FIG. 10, illustrating the manner in which the backing strip and stamps, labels, decals, stickers or the like are dispensed from the dispenser such that the stamps, labels, decals, stickers or the like are successively separated from the backing strip for subsequent adherence to a desired object.

### DETAILED DESCRIPTION OF THE ILLUSTRATED EMBODIMENTS

The scope of this invention includes provision of a unitary dispenser by which a stamp, sticker, label, decal or the like is separated from a coiled backing strip with a manual pull on an exposed protruding end of the backing strip, following which the stamp, sticker, label, decal or the like is lifted and separated from the backing strip at a discharge location of the dispenser. The separated label is then permanently adhere to the desired final location, such as on the face of an envelope. One hand may be used to conveniently facilitate separation.

As needed, the excess removed backing strip outside the dispenser may be torn away and discarded.

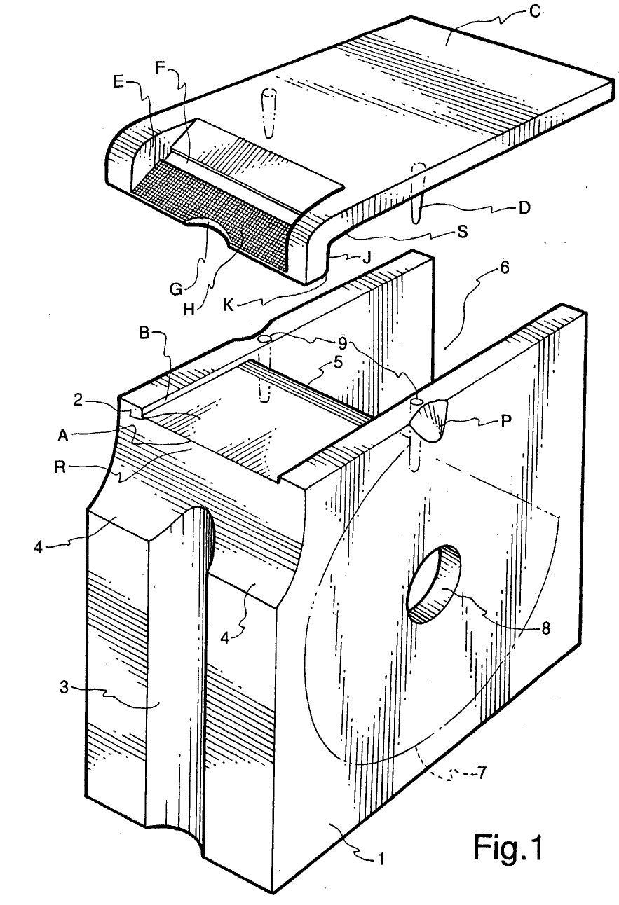

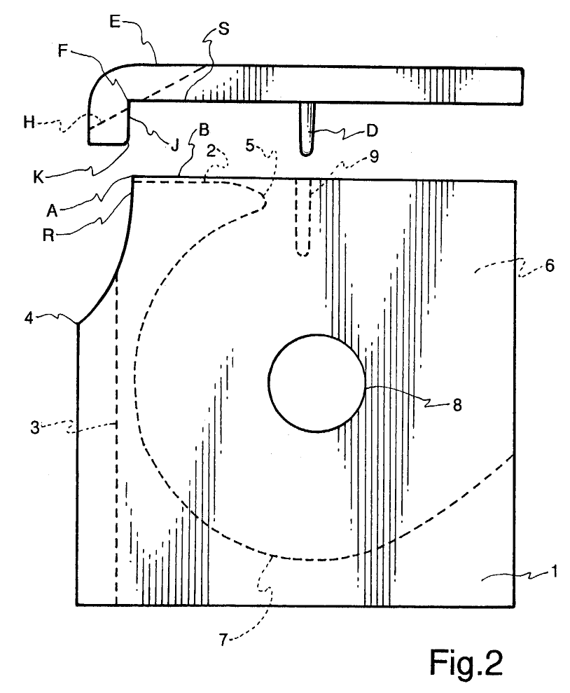

Referring now specifically to FIGS. 1-3 of the drawings, lid C is removable to accommodate the installation of a new label, sticker, decal or stamp roll or spool. This method of adding a new stamp roll or spool is very simple, easy, and rapidly done, so even people with very little dexterity can do the task easily.

This invention is designed to accommodate only adhesive backed stamps, labels, stickers or the like that are available on roll, spool or reel type packaging, as opposed to separation of stamps or labels from flat backing material.

When installing a new roll, two or three stamps or labels must be removed to expose a short section of backing strip with no stamps attached, to be laid over surface area 2. The first stamp must be behind corner A. The lid must be attached and exposed backing strip T must be long enough to protrude below the cam surfaces 4, so the fingers can grip and pull the backing strip T.

A is the right angle break-over 90° corner for traversal by the backing strip, which causes separation of the stiffer stamp from the backing strip.

B illustrates the shallow, controlled depth of the channel 2, which is only a few 1000^{th}s of one inch to insure aligned and controlled displacement of the backing strip with stamps removably adhered thereto to the discharge site.

C is the lid providing the upper boundary for the channel 2 and a right angle down turn J in respect to surface R, providing a shallow dimension, for guidance and displacement control. The backing strip T exits between surfaces J and R. A window F defines the discharge site for the separated stamp W. A serrated surface H is textured to prevent strong adhesive bonding with the stamp after separation from the backing strip T.

Protruding cams 4 to urge the backing strip T in an outward direction for easy access for gripping between the finger and thumb of one hand.

Groove 3 accommodates facile finger gripping of the backing strip T as well.

1 is the main body of the device.

6 is a cavity into which a roll, coil or spool comprised of a backing strip and stamps or other labels is placed.

7 is a circular base of the cavity 6 to accommodate the turning of the roll while being rotated during use. Since, in this embodiment, there is no axle, the roll continues to contiguously ride upon the bottom inside curved surface of the dispenser, as the diameter of the roll gets smaller.

5 is a ramp, over which the combined stamp and backing strip is pulled into the close tolerance of channel 2.

8 comprises two access holes to accommodate the finger as needed to adjust the adhesive roll while loading new roll, or for insertion of an axle, if desired.

P are indentations on each side of the device to accommodate the finger access for gripping the lid C for its easy removal.

9 are the holes to receive the so called “banana plugs” D. The details of the “banana plugs” are well known in the electronic industry. They fit the holes snugly but are removable, against a controlled friction force.

Banana plugs D are expandable and contractible as determined by the diameter of the holes in which they are inserted. When the lid C has been pushed down, by inserting the banana plugs into the holes 9, the friction of the plugs holds lid C firmly in place. This friction force can be overcome by manually lifting the lid C.

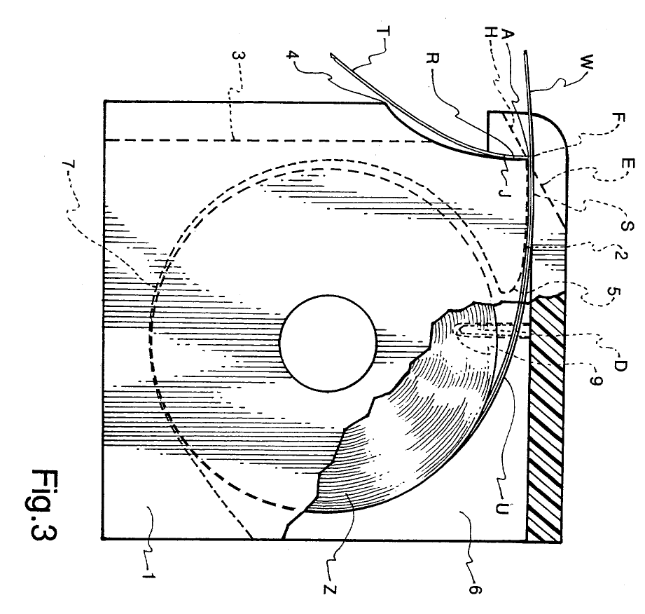

E is an angled cut away which creates a window F precisely at the junction of the inside corner of under-surface S and the right angle vertical surface J. When the lid C is pressed into place by inserting the banana plugs D into the holes 9, the window F is aligned with the right angle corner A so that the corner A is near the center of the window opening F. (See FIG. 3.) While the lid C is in the assembled position and held fast to the body 1, the surface of channel 2 is in a close fixed distance as determined by the dimensions of B. This space is preferably approximately 0.001″ to 0.002″ greater than the thickness of the combined stamp backing strip U before separation.

The distance between the surface J and the surface R is also approximately 0.001″ to 0.002″ greater than the thickness of the backing strip T after separation from the stamp. The purpose of these close tolerances is to cause the stamp to stay in a generally horizontal plane as it passes through the window F while the backing strip T is pulled down between the passage J and R causing it to bend abruptly over corner A causing mechanical separation of the stamp W from the backing strip T. (See FIG. 3.)

The pulling of the backing strip T downward is stopped, by the person using the device, when a single stamp or label is completely out of the window F. The now exposed adhesive side of the stamp, or label will contact the textured or serrated surface H and stop, without substantial adherence thereto. The stamp is then ready to be picked up with the fingers of one hand easily, as one finger is lifted up through the opening G. (See FIG. 1.)

The textured surface H is such that only a small percentage of its surface is contacted by the adhesive. This makes strong adherence impossible and accommodates easy removal for use.

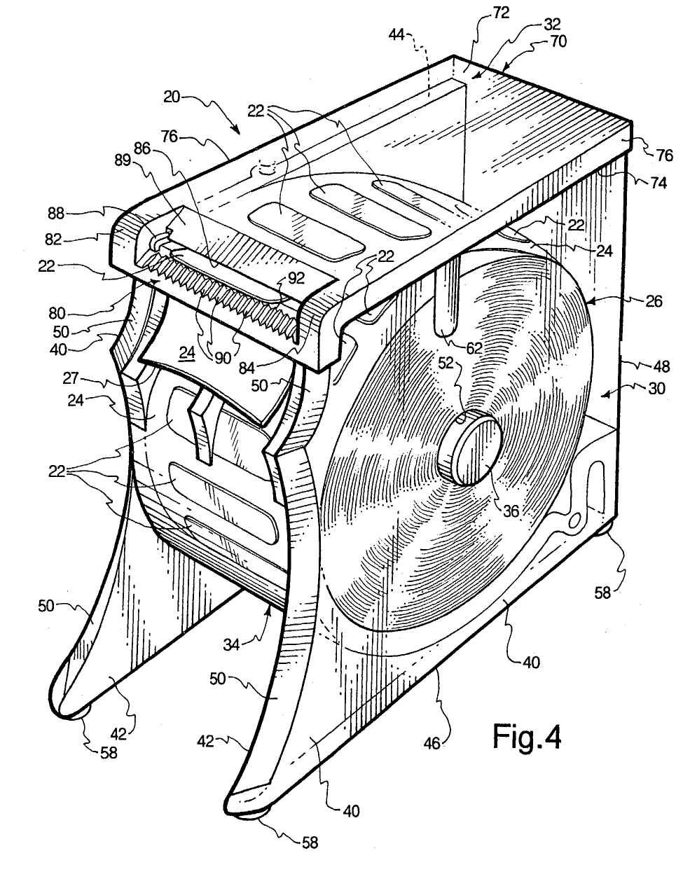

Reference is now made to FIGS. 4 through 9, which illustrate a second dispenser embodiment, generally designated 20, by which labels, stickers, decals, stamps or the like (hereinafter sometimes individually and collectively called “labels”) are dispensed by successively mechanically separating each label 22 from a backing strip 24, upon which the labels are releasibly adhered. Typically the labels 22 will display desired indicia, such as printed information and/or pictorial representations, but such is not necessary to carry out the present invention. In other words, blank labels 22 without indicia may be dispensed from the dispenser 20 or any other dispenser embodying principles of the present invention.

As can be seen plainly from FIG. 4, the backing strip 24, which may comprise Kraft paper or other suitable material, is disposed as a spool or coil, generally designated 26. Typically, but not necessarily, the spool 26 of backing material 24 is coiled in such a way as to form a central cylindrical opening 28 at the center of the spool 26, for purposes yet to be explained.

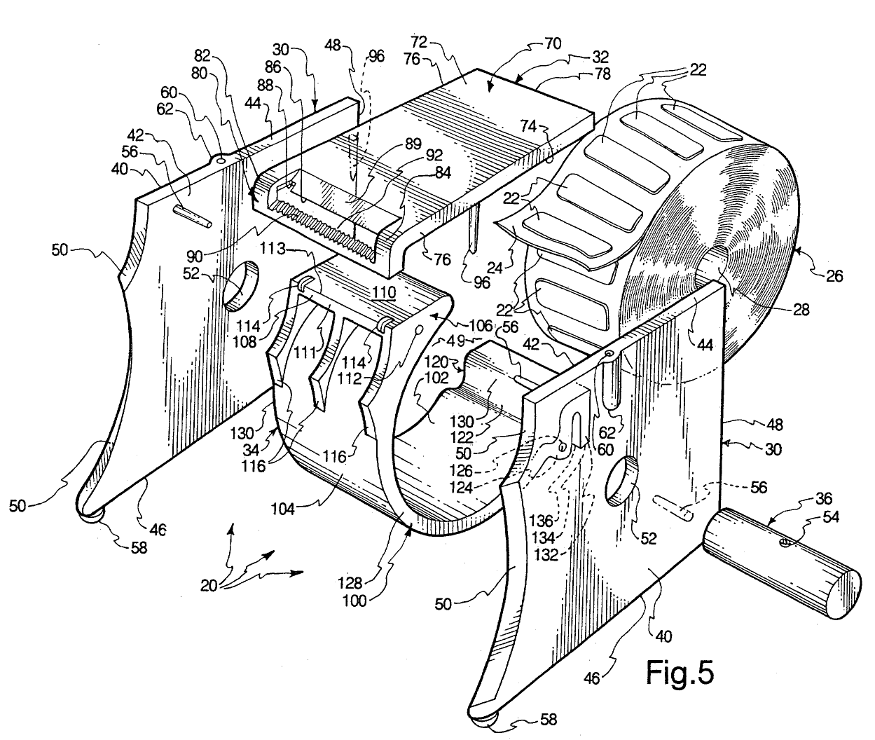

The dispenser 20 is comprised of two identical, though opposite hand, flat side walls, each generally designated 30, a top L-shaped lid generally designated 32 and a bottom curved wall portion, generally designated 34. The provision of a shaft or axle, generally designated 36 (in FIG. 5), is optional, as explained herein in greater detail.

It is presently preferred that the dispenser members 30, 32 and 34 be formed of suitable impact resistant synthetic resinous material using known and commercially available molding techniques, such as injection molding techniques. Polycarbonate is suitable. One or more multiple cavity molds may be used so that all of the plastic parts of dispenser 30 are simultaneously formed. Furthermore, if desired, a multiple cavity mold can be utilized wherein all of the plastic parts necessary for a plurality of dispensers 20 may be simultaneously molded.

The identical though opposite hand side walls 30 each comprise an outside surface 40 and an inside surface 42 thereby defining, with two exceptions, a layer of material having essentially a uniform thickness. Each side wall 30 further comprises an upper, generally horizontal edge surface 44, a lower, generally horizontal edge surface 46, a back generally vertical edge surface 48 and a front undulating, beveled edge surface 50. The described edges merge along two upper and two lower comers, as can be seen from inspection of FIGS. 4 and 5. A central aperture 52 of predetermined size is horizontally disposed in each of the side walls 30, the apertures 52 being horizontally aligned when the dispenser 20 is assembled, as shown in FIG. 4.

When used, the shaft 36, the diameter of which is somewhat less than the identical diameter of the two apertures 52, is linearly displaced through one aperture 52, through the central spool opening 28 and thereafter through the other aperture 52 into, essentially, the position illustrated in FIG. 4. Thus, the shaft 36 functions as an axle, when used, accommodating easy rotation of the spool 26 when the user pulls on the backing strip 24 at a location outside the dispenser 20.

The shaft 36 is illustrated as being equipped with a set screw 54, threadedly disposed in a blind bore in the shaft 36, so that the set screw 54 can be turned in and out of the shaft to allow the set screw 54 to create a compression fit with the material of the backing strip 24 located at throughbore 28 to prevent inadvertent removal of the shaft 36 from the dispenser 20, when assembled. The length of shaft 36 is selected, preferable, to be slightly longer than the horizontal distance between the wall surfaces 40 of the two side walls 30.

The side walls 30 each comprise two inwardly directed tapered pins or dowels 56, formed as one piece with the associated side wall 30. The pins 56, as explained herein in greater detail, assist in assembling the side walls 30 and the bottom wall 34 inseparably into a single integrated unit.

Each side wall 30, near the respective ends of the lower edge 46 is illustrated as comprising adhesively secured antifriction feet or pedestals 58 to assist in stabilizing the dispenser upon a desk, table or other surface. These feet are commercially available and may be composed of polyvinyl material.

The lengths of edges 44, 46 and 48 are selected to accommodate assembly of the parts comprising dispenser 20 and to assist in forming an interior compartment 49, the size of which accommodates receipt of the spool 26 at maximum diameter, prior to dispensing of any label 20 from the backing strip 24.

Each side wall 30 comprises a blind bore 60, extending in a vertical direction and opening at top edge 44. To accommodate an appropriate dimension for the two blind bores 60 the wall of each element 30 is enlarged to form bulb-like protrusion 62 at surface 40 to accommodate the required diametral size for the associated blind bore 60. Blind bores 60 accommodate removable placement of pins or dowels of the lid 32 over the two side walls 30, as explained herein in greater detail.

The lid 32 comprises an L-shaped one piece member comprised of a horizontally disposed long leg 70 comprising a generally horizontally disposed layer comprising an outside surface 72, an inside surface 74, parallel side edges 76 and end or rear edge 78. Horizontal flat leg 70 is formed as one piece and merges with a short vertical leg 80 which connects at opposed rounded side corners 82 and 84 to horizontal leg 70. Between the two side comers 80 and 84 is disposed a transverse slot or elongated horizontally directed aperture 86, through which the labels 22 successively pass after being separated from the backing strip 24. The aperture 86 is interrupted directly juxtaposed or adjacent to the comers 82 and 84 respectively by a side notch 88. The two notches 88 assist in placing the lid 32 correctly upon the bottom element 34, as explained hereinafter in greater detail.

To the rear of the slot 86 is disposed a tapered or diagonal surface 89 in the leg 70. Forward of the slot 86 is a serrated or undulating diagonal surface 90 comprising peaks and valleys so that each label, when separated from the backing 24 and discharged through the slot 89, will have a minimal label-adhering contact with the lid 32 at serrations 90 making retrieval and subsequent placement of the label on a desired object facile for the user of the dispenser 20. The serrations 90 are disposed from back to front in a sloped or ramp orientation so that gravity is constructively used in the label separation and retrieval part of the process. The serrated region 90 comprises a back corner surface 92, which assists in defining a space through which the backing strip 24 passes as and after a label 24 is removed therefrom, the label being displaced in a forward and somewhat downward direction across the serrations 90.

The dispenser 20 is preferably formed of synthetic resinous material, which is not only transparent but, as mentioned above is also durable and not frangible when dropped or otherwise mishandled.

As best seen in FIG. 5, the removable lid 32 comprises a pair of aligned tapered pins 96, which are formed as one piece with and extend downwardly from the flat plate-like leg 70, to accommodate removable connection with the side walls or plates 30. More specifically, the tapered pins 96 are located and sized to fit snugly, but not in compression fit relationship with the tapered blind bores 60, which open along the top surface 44 of each side wall 30. Thus, when the two side walls 30 are in assembled relationship, as shown in FIG. 4, the lid 32 is moved forcibly downwardly until the pins 96 enter and are fully inserted into the tapered bores 60. Striking of the lid with the palm of one hand will complete this part of the assembly. The fit is snug, making inadvertent removal difficult if not impossible, but an upward force, appropriately applied to lid 32 accommodates removal of the lid 32, following which spool 26 can be inserted (or removed, if that proves to be desirable at any point in time).

It is to be noted that the pins 96 are disposed in transversely aligned relationship one with the other at positions more closely spaced toward leg 80 and spaced from edge 78 by a greater distance. This prohibits inadvertent reverse placement of the lid 32 upon the side walls 30.

Central element 34 of the dispenser 20 comprises a horseshoe-shaped curved structure comprising a circular wall segment 100 comprising an interior circular surface 102 and an exterior circular surface 104, thereby defining a layer of centrally-disposed material having essentially a uniform thickness.

The wall 100 is enlarged at an upper, elevated end 106. Upper enlarged end 106 defines a platform 108 comprising a flat upper surface 110, illustrated as being generally horizontally disposed and across which the backing strip 24 from spool 26 is displaced, with the lid 32 removed. Horizontal surface 110 merges with vertical surface 111 at comer 113.

The upper end 106 comprises opposed tapered horizontally-directed blind bores 112 (only one of which is illustrated), which are sized, shaped and located to respectively receive a tapered pin or dowel 56 of the adjacent wall 30 in a compression fit, non-removable relation during assembly of the dispenser 20.

The platform 108 comer 113 comprises a pair of rectangular projections 114, located, sized and shaped to be received in slots 88 of the lid 32 to accurately position the lid 32 in it assembled condition, thereby providing for aligned and guided displacement of the backing strip 24 and labels 22 in respect to the dispenser 20.

The upper enlarged end 106 of the curved member 34 also comprises a plurality of front ribs 116, which collectively define an exit path for the backing strip 24, but also reinforce and strengthen the rigidity of the element 34.

The central curved member 34 of the dispenser 20 further comprises a lower back end, generally designated 120, which is transversely undulating or grooved at site 122. End 120 comprises an enlarged boss region 124 below the groove 122, with opposed tapered blind bores 126 being disposed therein and exposed at the opposed edges 128 and 130. The tapered blind bores 126 (only one of which is illustrated in FIG. 5), are located, sized and shaped so as to receive the tapered pin 56 in compression fit, non removable relationship when the walls 30 are connected to the central, circular member 34. Typically, a mallet of hard rubber or the like may be used to strike the exterior surface of the adjacent wall 30 to drive the associated pin 56 into the aligned, adjacent blind bore 26.

The trailing end 120 of the member 34 further comprises a reverse curve wall segment 130 located rearward of groove or undulation 122, which emerges into a downwardly extending wall 132. Wall 132 comprises a lower horizontally directed transverse edge 134, which may be contained in the same plane as edges 46, when the dispenser 20 is assembled, or may be slightly above that plane. Vertical wall I 32 is spaced from the remainder of the trailing end 120 by a V-shaped gap 136.

To prepare the dispenser 20 of FIGS. 4 through 9 for use, typically, the lid 32 is removed from the remaining assembled elements of the dispenser 20. The spool 26 is positioned within the cavity 49 formed by assembled walls 30 and 34. If a shaft 36 is used, it is extended through one aperture 52 in one wall 30, through the central cylindrical hollow region 28 of spool 26 and through aperture 32 in the second wall 30, into the position illustrated in FIG. 4. Otherwise, the exterior surface of the spool 26 rests upon the interior surface 102 of the element 34 and turns thereon as the user pulls on the backing strip 24 to consecutively remove the labels 22.

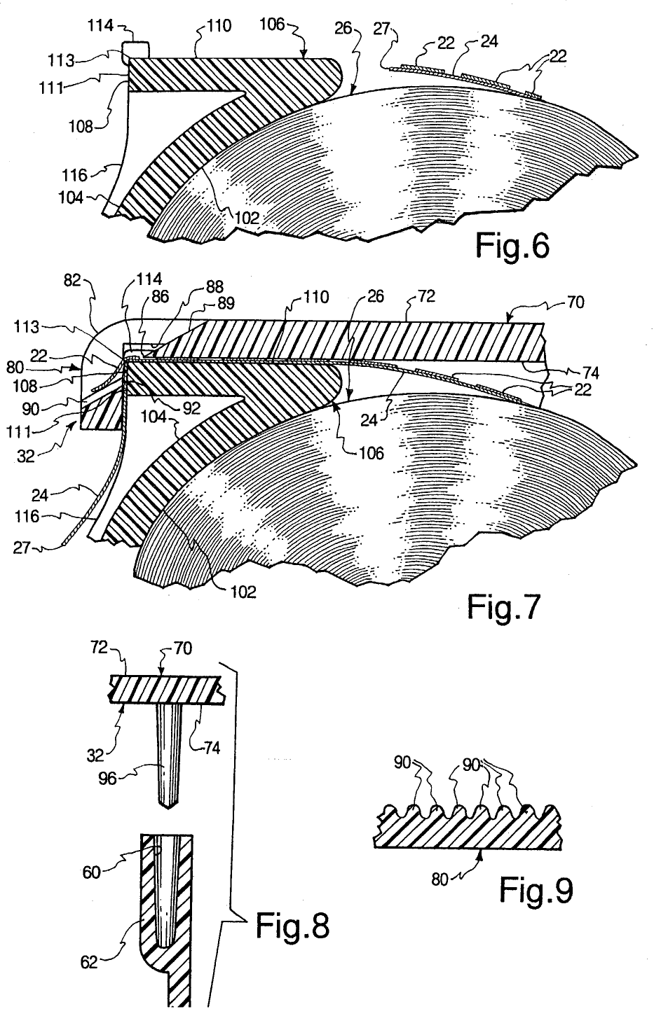

The free end 27 of the backing strip 24 is positioned at the top of the spool 26, across and somewhat beyond the platform surface 110. See FIG. 6. The backing strip 24 is displaced over corner 113 and along surface 111. The distance the edge 27 should be extended beyond the forward end of surface 110 should be substantially greater than the length of leg 80 of lid 32, to allow the user to grasp the backing strip 24 at flanges 116 after the lid is positioned in its assembled condition. This may require manual removal of one or two labels 22 without the benefit of the dispenser 20, in order to provide the necessary discharge length of backing strip 24 for manual grasping.

Once the backing strip 24 has been positioned as described immediately above, the lid 32 is positioned in the manner explained earlier into its assembled, though removable location. Contrast FIG. 6, where the lid is shown as having been removed, with FIG. 7, where the lid is shown as having been positioned above the strung label-bearing backing strip 24. When the exposed end 27 of the backing strip 24, in its assembled position illustrated in FIGS. 4 and 7, is pulled, the backing strip is displaced along a path defined by surface 110, corner 113, through essentially a sharp 90 degree angle, and surface 111. This will initially release the leading edge of a label 22 from the backing strip at corner 113 where the surfaces 110 and 111 intersect.

Further manual displacement of the backing strip 24 will cause the separated edge of the label juxtaposed to the intersection of surfaces 110 and 108 to ride over the serrations 90 in a forward and downward direction, as best shown in FIG. 7. With adequate displacement of the backing strip 24, the separated label 22 will rest in light adherence upon the serrations 90, at which time the user will manually remove the label 22 and place it upon a desired object, such as an envelope when the label is a stamp, an article of merchandise for sale where the label is a price-related merchandising sticker, etc. Because the surface area contact between the separated label 22 and the serrations 90 is only along the elevated projections, significant adherence between the separated label and the serrations 90 does not occur.

The dispenser 20, accordingly separates labels 22 automatically or mechanically from the backing strip 24 at the corner 113 where surfaces 110 and 111 intersect, normally without the requirement of human intervention. It follows that labels 22 may be separated and discharged successively in somewhat of a rapid fashion to accommodate short term repeated placement of successive labels upon the desired object.

When the supply of labels 22 of a given spool 26 is exhausted or when a different spool, such as a spool with a different species of labels thereon is desired, the lid 32 can be manually removed by physically grasping the lid 32 and lifting it so as to separate the tapered pins 96 from the blind tapered bores 60. The shaft 36 is slideably removed from the dispenser 20. The old spool 26, if it exists, is removed, the new spool is inserted, the shaft 36, if it used, is reinserted as explained earlier, the backing strip with different labels thereon is threaded across surface 100 and down surface 108, in the manner explained above, and the lid is returned to its assembled snug but removable position, as shown in FIG. 7.

In order for the dispenser 20 to operate effectively, it is preferred that the gap between surface 110 and 74 be on the order of 9-10 one thousandths of one inch and the gap between surface 108 and 92 be on the order of 1-2/1000 of one inch greater than the combined thickness of the backing strip 24 and the labels. The same tolerance is preferred for the gap between the surfaces 111 and 92.

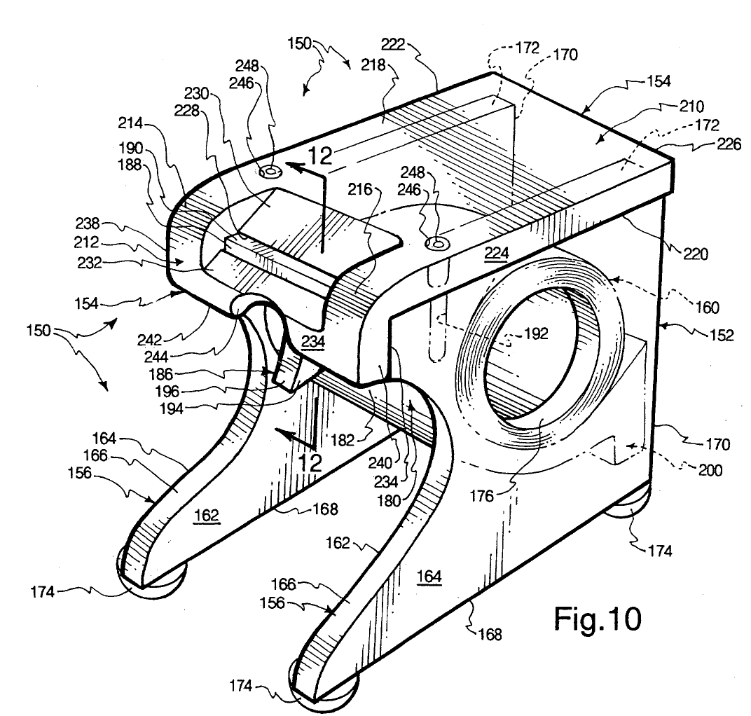

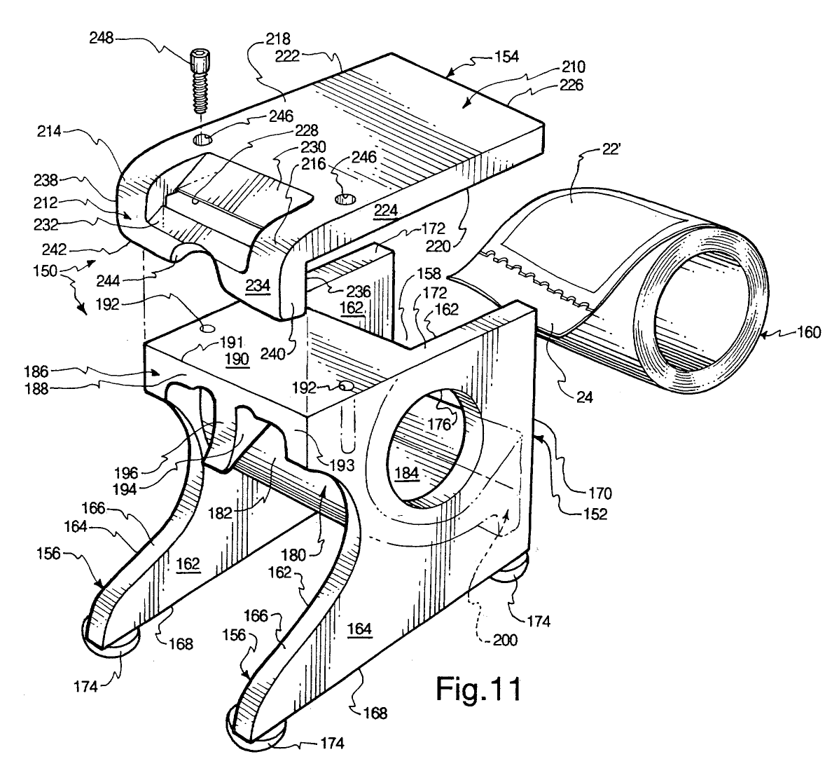

Reference is now made to a third embodiment of the illustrated in FIGS. 10 through 12 and generally designated 150. Sticker, decal, stamp, label or the like dispenser 150 comprises two primary parts, a one-piece main body, generally designated 152, and a lid, generally designated 154. While main dispenser body 152 is formed as one piece, preferably by injection molding, it comprises several structural portions or features including two parallel side walls, each generally designated 156, which are identical or substantially so, but of opposite hand. While the dispenser 150 can be of any desired size for dispensing labels, one kind or another, the dispenser 150 may be relatively small in size to accommodate a roll of stamps placed within a hollow compartment 158 (FIG. 11) between the side walls 156, wherein a central mounting shaft for the spool 160 is not illustrated as being used, although a shaft or axle could be. between the side walls 156, wherein a central mounting shaft for the spool 160 is not illustrated as being used, although a shaft or axle could be.

Side walls 156 of main body member 152 are illustrated as comprising interior and exterior walls surfaces 162 and 164, respectively, the surfaces 162 and 164 being spaced from each other by a dimension comprising a uniform predetermined thickness. The side walls 156 comprise front curvilinear front edge surface 166, bottom edge surface 168, back edge surface 170 and top edge surface 172. Edge 168 of each side wall 156 is equipped with adhesively secured yieldable feet or pedestals 174, which are commercially available and which not only support the load imposed by dispenser 150, but prevent inadvertent walking displacement of the dispenser 150 along a surface upon which the dispenser 150 is placed, such as a tabletop, desk top or other surface.

The dimensions of the two side walls 156 are sized and shaped so as to define the cavity or compartment 158 therebetween, which is suitably dimensioned to receive loosely the spool 160 of stamps 22′ mounted upon a coil of the backing material 24. Each side wall 156 defines a central aperture 176, capable of receiving a central shaft for rotationally mounting the spool 160, if that is desired.

The dispenser 150 is formed of synthetic resinous material which is durable and nonfrangible. Preferably, the parts 152 and 154 are formed of transparent synthetic resinous material to allow visual inspection of the spool of labels contained therein, without requiring disassembly or extra effort, although non-transparent dispensers embodying principles of the present invention fall within the scope of this invention.

The spool-receiving element 152 of the dispenser 150 further comprises a central circularly curved wall 180 extending between and formed as one piece with side walls 156. The central wall 180 comprises an exterior curved surface 182 and an interior curved surface 184 upon which the spool 160 contiguously rests and turns in the assembled condition.

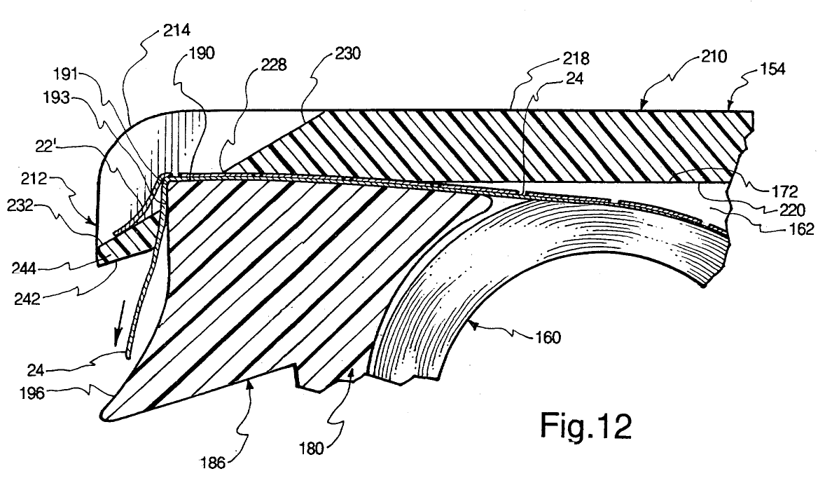

The central member 180 comprises an upper enlarged end, generally designated 186, which defines a platform 188 comprising an upper horizontal surface 190. Upper surface 190 defines two threaded blind bored 192, which are transversely aligned one with the other for purposes of connecting the member 152 and the member 154 in the correct assembled position. The backing strip passes over surface 190 around comer 191 and along vertical surface 193. The upper end portion 186 further comprises a ramp-defining flange 194, which comprises an exposed curved ramp surface 196 which turns the backing strip 24 towards the user for ease of grasping, as best shown in FIG. 12.

The central curved wall 180 comprises an enlarged trailing end portion, generally designated 200, which also is formed as one piece with the other elements of member 152. End portion 200 assists in cradling the spool 160 within the compartment 158.

Lid 154 comprises an L-shaped member comprising a long, generally horizontal directed leg, generally designated 210, and a shorter vertically directed leg, generally designated 212. Thus, legs 210 and 212 are essentially disposed at right angles to one another, being formed as one piece so as to be joined together at spaced side comers 214 and 216. Leg 210 is defined by top and bottom wall surfaces 218 and 220, which are uniformly spaced one from the other so as to define a wall of essentially uniform thickness. Leg 210 also comprises blunt side edges 222 and 224 and back blunt edge 226.

Between comers 214 and 216 is disposed a rectangularly-shaped slot 228 through which the backing strip 24 and the stamps 22′ are dispensed from the dispenser 150. Slot 228 is located just forward of a tapered ramp surface 230 disposed in leg 210 and just behind tapered wall surface or stamp-receiving ramp 232.

Leg 212 comprises an exterior surface 234, an interior surface 236, two side edge surfaces 238 and 240, which are contained within the same planes which contain edges 222 and 224, respectively. Leg 212 further comprises a lower edge 242, which defines a central curved recess 244, to provide improved manual access to the exposed end of the backing strip 24, accommodating grasping and pulling thereon to successively discharge and separate stamps 22′ from the backing strip 24, as best shown in FIG. 12. Juxtaposed tapered wall surface 230 are spaced and transversely aligned throughbores 246, which are sized and vertically positioned so as to be compatible and aligned with threaded blind bores 192. The throughbores 246 and blind bores 192 are located closer to the front of the dispenser 150 than to the rear, to ensure that the lid 154 is not inadvertently placed in an incorrect reverse orientation upon the dispenser member 152. When the lid 154 is correctly positioned upon lower member 152, an allen screw 248 is fitted through each of the throughbores 246 and threaded into the blind bores 192 to secure the lid in its assembled condition. To remove the lid 154, the two allen screws are turned in a counterclockwise direction until they become separate from the members 152 and 154.

Ordinarily, with the lid 154 removed, the spool 160 is inserted into the compartment 158 and its leading end threaded across surface 190, with the backing strip 24 being threaded around comer 119 and downwardly along surface 193, with the leading stamp being partially separated from the backing strip 24 so as to be displaced along diagonal surface 232. When the lead stamp 22′ is completely separated from the backing strip 24, the user of the dispenser 150 can place one finger in the recess 244 and the other over top of the separated stamp 22′ to retrieve the same from the separation of the lead stamp 22′ does not occur until following placement of the lid 154 in its proper and secured position above the member 152, as best illustrated in FIG. 12.

The invention may be embodied in other specific forms without departing from the spirit of the central characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A dispenser for consecutively dispensing adhesively-backed serially-disposed labels from a roll comprised of a backing strip comprising:
a roll-receiving compartment accommodating roll rotation in the compartment;
a bifurcating discharge region comprising:
(a) a channel through which the backing strip and the series of labels are displaced;
(b) a sharp comer around which the backing material is displaced as the backing strip exits the channel, whereby the backing strip is peeled successively from each label of the series;
(c) a label-receiving exposed surface spaced horizontally forward of the sharp comer across on to which each label is displaced as the backing strip is peeled therefrom;
(d) an exit passageway for the peeled backing strip extending generally vertically downward from the sharp comer.

2. A dispenser according to claim 1 wherein the compartment is defined by two side wall portions, a central portion and a removable top lid.

3. A dispenser according to claim 1 wherein the channel is close tolerance defined by two side wall portions, a central portion and a removable lid.

4. A dispenser according to claim 1 wherein the label-receiving exposed surface comprises part of a removable li of the dispenser

5. A dispenser according to claim 1 wherein the dispenser comprises a compartment defining main body and a lid removably and stably connected to the main body.

6. A dispenser according to claim 5 wherein the connections between the main body and the lid comprise male/female connectors.

7. A dispenser according to claim 6 wherein male/female connectors are tapered pins and blind bores.

8. A dispenser according to claim 1 wherein the dispenser comprises resilient anti-displacement feet for supporting the dispenser upon a desired surface.

9. A dispenser according to claim 1 further comprising an axle supported by the dispenser transversely across the compartment and through a hollow center of the roll to accommodate roll rotation.

10. A dispenser according to claim 1 wherein the compartment comprises an interior curved surface upon which the roll rests and turns.

11. A dispenser according to claim 1 wherein the dispenser comprises a main body, two side walls and a central portion disposed between the side walls.

12. A dispenser according to claim 11 wherein the side walls and the central portion are formed as one piece.

13. A dispenser according to claim 11 wherein the side walls and the central portion are formed as three separate pieces and non-removably connected to form the main body.

14. A dispenser according to claim 13 wherein the connections are compression fit male and female connections.

15. A dispenser according to claim 14 wherein the male and female connectors are tapered pins and tapered blind bores.

16. A dispenser according to claim 1 wherein the dispenser comprises durable non-frangible transparent synthetic resinous material.

17. A dispenser according to claim 1 wherein the label-receiving exposed surface is undulating to reduce the area thereof contacted by the adhesive of each label.

18. A dispenser according to claim 1 further comprising male guide at the sharp comer to control displacement of the backing strip.

19. A dispenser according to claim 1 wherein the dispenser comprises an L-shaped lid of which the label-receiving exposed surface comprises a part thereof, the label-receiving exposed surface comprising an anti-adhering surface.

20. A dispenser according to claim 1 wherein the dispenser comprises a main body and a removable lid with connectors between the main body and the removable lid, the connectors being located to accommodate placement of the lid on the main body in a single orientation only.

21. A method of dispensing adhesive-carrying labels, stickers, decals, stamps and the like from a backing strip, comprising the acts of:
placing a roll comprised of the backing strip and labels, stickers, decals, stamps or the like adhered to the backing strip cradled in compartment of a dispenser;
threading a leading end of the roll through a discharge site of the dispenser such that the backing strip traverses a sharp comer and a leading end of the backing strip is exposed for manual grasping outside the dispenser pulling on the exposed backing strip to rotate the roll within the dispenser, advance a label, sticker, decal, stamp or the like adhered to the backing strip to the discharge site . . .
initiating separation of the label, sticker, decal, stamp or the like by causing a leading edge of the label to be peeled from the backing strip as the backing strip traverses the sharp comer;
completing separation of the label from the backing strip by further manual displacement of the backing strip causing the leading edge of the label to engage and traverse a label discharge surface;
manually grasping the separated label at label discharge surface for adhered placement on a desired object.

22. A method of consecutively dispensing adhesively backed labels from a roll comprising a backing strip, the acts of;
turning the roll within a dispenser by pulling on an exposed end of the backing strip;
successively separating the labels from the backing strip to discharge from the dispenser the labels along one discharge path and the backing strip along another discharge patch by successively first mechanically peeling the backing strip at a sharp angle from a leading edge of the labels and directing the leading edge along a low adherence separated label-receiving surface of the dispenser.
